(19) United States
(12) Patent Application Publication
(10) Pub. No.: US 2015/0281367 A1
(43) Pub. Date: Oct. 1, 2015

(54) MULTIPATH TCP TECHNIQUES FOR DISTRIBUTED COMPUTING SYSTEMS

(71) Applicant: Akamai Technologies, Inc., Cambridge, MA (US)

(72) Inventors: Erik Nygren, Somerville, MA (US); Moritz M. Steiner, San Francisco, CA (US)

(73) Assignee: AKAMAI TECHNOLOGIES, INC., Cambridge, MA (US)

(21) Appl. No.: 14/669,853

(22) Filed: Mar. 26, 2015

Related U.S. Application Data
(60) Provisional application No. 61/970,621, filed on Mar. 26, 2014.

(51) Int. Cl. H04L 29/08; H04L 29/06; H04L 12/801

(52) U.S. Cl. CPC H04L 67/14; H04L 47/193; H04L 65/1066

(57) ABSTRACT

In non-limiting embodiments described herein, multipath TCP can be implemented between clients and servers, the servers being in a distributed computing system. Multipath TCP can be used in a variety of ways to increase reliability, efficiency, capacity, flexibility, and performance of the distributed computing system. Examples include achieving path redundancy, connection migration between servers and between points-of-presence, end-user mapping (or -remapping), migration or path redundancy for special object delivery, and others.

This application is based on and claims the benefit of priority of U.S. Application No. 61/970,621, filed Mar. 26, 2014, the teachings of which are hereby incorporated by reference in their entirety.

### BACKGROUND

1. Technical Field

This application relates generally to distributed data processing systems and to the delivery of content to users over computer networks.

2. Brief Description of the Related Art

Transmission control protocol (TCP) is a well-known protocol for communicating between network hosts. It is commonly used on the Internet, where clients may communicate using TCP with servers to retrieve web page content. TCP is often used in conjunction with Internet Protocol (IP) in order to transport HTTP application layer data. In theory, however, TCP can be used for transport of virtually any kind of data.

Traditional TCP connections subsist on a single path between two hosts. The term ‘path’ is used to mean a sequence of one or more links between a sender and a receiver, which is typically defined by a 4-tuple of source and destination address and port pairs. The hosts send and receive data across this path.

Recently, an enhancement to TCP has been developed called multipath TCP, or MPTCP. MPTCP is essentially a set of extensions to traditional TCP. As its name suggests, MPTCP provides a way to establish a multipath TCP connection between two hosts, each path carrying a subflow, which is a flow of TCP segments. The subflows are all part of the same TCP connection. MPTCP provides a way for the data flowing across each of the paths to be managed and ordered within the overall TCP connection, transparent to upper network layers and, in particular, transparent to an application like a web browser.

The use of multiple paths between two hosts can reduce latency and increase communication fault tolerance and reliability. Multipath communication is particularly useful if a host is multi-homed and/or has multiple addresses. For example, a wireless device may have both a WiFi interface and a cellular interface; the wireless device will have a different address for each. Using multipath TCP, each interface can be used as a separate path to a given server, such that both interfaces are leveraged to send and receive data. Even if separate interfaces are not available, a given host with multiple addresses can establish multiple subflows over them.

More information about MPTCP can be found in IETF RFCs 6181, 6182, 6356, 6824, and 6897.

Also known in the art are distributed computing systems. One kind of distributed computing system is a content delivery network (CDN). The teachings hereof relate to, among other things, improved techniques for communicating data within or across a distributed computing platforms (including in particular CDNs), and for delivering such data from servers in the distributed computing platform to requesting clients, using MPTPCP. The teachings hereof improve the efficiency, capacity, flexibility, and performance of such distributed computing systems and client-server communication.

### BRIEF DESCRIPTION OF THE DRAWINGS

The teachings hereof will be more fully understood from the following detailed description taken in conjunction with the accompanying drawings, in which:

FIG. 1 is a schematic diagram illustrating an embodiment of a known distributed computer system configured as a content delivery network (CDN);

FIG. 2 is a schematic diagram illustrating an embodiment of a machine on which a CDN content server in the system of FIG. 1 can be implemented;

FIG. 3 is a schematic diagram illustrating an embodiment of a CDN platform functioning as an Internet overlay;

FIG. 4A is a schematic diagram illustrating use of a multipath TCP connection across multiple CDN servers, in one embodiment;

FIG. 4B is a schematic diagram illustrating use of a multipath TCP connection across multiple CDN servers, in one embodiment;

FIG. 5 is a schematic diagram illustrating use of a multipath connection between CDN servers and an origin server, in one embodiment; and

FIG. 6 is a block diagram illustrating hardware in a computer system that may be used to implement the teachings hereof

### DETAILED DESCRIPTION

The following description sets forth embodiments of the invention to provide an overall understanding of the principles of the structure, function, manufacture, and use of the methods and apparatus disclosed herein. All systems, methods and apparatus described herein and illustrated in the accompanying drawings are non-limiting examples; the claims alone define the scope of protection that is sought. The features described or illustrated in connection with one exemplary embodiment may be combined with the features of other embodiments. Such modifications and variations are intended to be included within the scope of the present invention. All patents, publications and references cited herein are expressly incorporated herein by reference in their entirety. Throughout this disclosure, the term “e.g.” is used as an abbreviation for the non-limiting phrase “for example.”

### INTRODUCTION

According to the teachings hereof, multipath TCP can be implemented between clients and servers in a distributed computing system in unintended ways to solve content delivery problems, and to increase reliability, efficiency, capacity, flexibility, and performance of the distributed computing system.

As used here, distributed computing systems include—without limitation—content delivery networks (CDNs). Many of the techniques described herein are described in the context of a CDN, solely for illustrative purposes. However, the teachings hereof can be used, without limitation, in any distributed computing system that interacts with clients for delivery of content or services or otherwise. By way of background, CDNs are often operated and managed by a service provider. The service provider typically provides the content delivery service on behalf of multiple third parties, although a CDN can also be built to deliver one's own content. A distributed system of this type typically refers to a collection of autonomous computers linked by a network or networks, together with the software, systems, protocols and techniques designed to facilitate various services. The infrastructure is typically used for the storage, caching, or transmission of content—such as web pages, streaming media and applications—on behalf of such content providers or other tenants. The platform may also provide ancillary technologies including, without limitation, DNS query handling, provisioning, data monitoring and reporting, content targeting, personalization, and business intelligence.

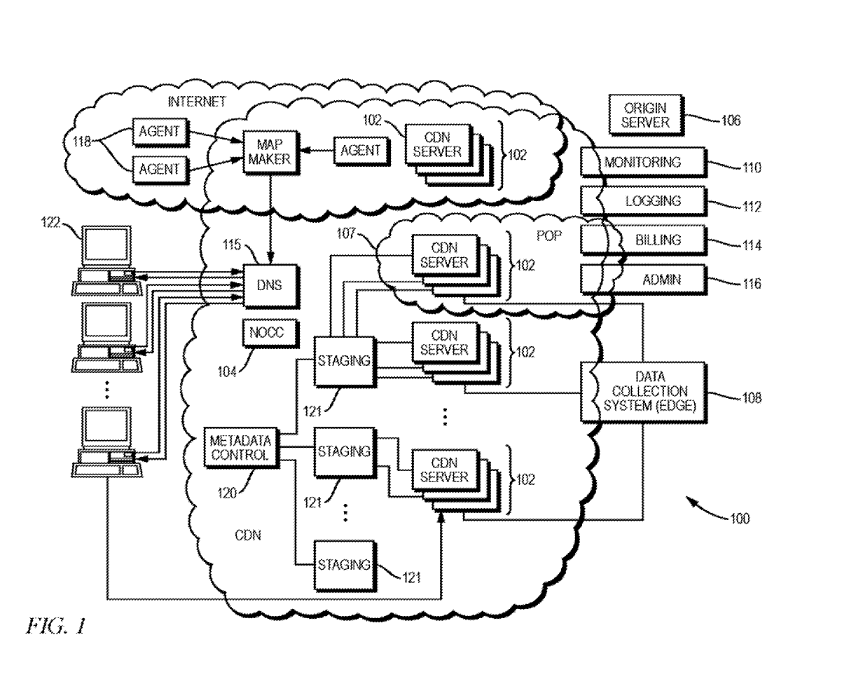

An exemplary distributed computing system configured as a CDN is shown in FIG. 1. Distributed computer system 100 has a set of content servers 102 (referred to below as the CDN's servers 102) distributed around the Internet. Typically, most of the servers are located near the edge of the Internet, i.e., at or adjacent end user access networks. A network operations command center (NOCC) 104 may be used to administer and manage operations of the various machines in the system. Third party sites affiliated with content providers, such as web site 106, offload delivery of content (e.g., HTML or other markup language files, embedded page objects, streaming media, software downloads, and the like) to the distributed computer system 100 and, in particular, to the CDN's servers 102. Such servers may be grouped together into a data center, also referred to as a point of presence (POP) 107, at a particular geographic location, which is also sometimes referred to as a “region.”

The CDN's servers 102 are typically located at nodes that are publicly-routable on the Internet, in end-user access networks, peering points, within or adjacent nodes that are located in mobile networks, in or adjacent enterprise-based private networks, or in any combination thereof

Typically, content providers offload their content delivery by aliasing (e.g., by a DNS CNAME) given content provider domains or sub-domains to domains that are managed by the service provider's authoritative domain name service. The service provider's domain name service directs end user client machines 122 that desire content to the distributed computer system (or more particularly, to one of the CDN servers in the platform) to obtain content more reliably and efficiently. More specifically, when a recursive DNS server makes a request (on behalf of the client machine 122) to the service provider's authoritative DNS to resolve a given domain, the service provider's DNS service typically consults a ‘map’ created by the map maker that indicates a selected CDN server (or set thereof) to return, based on the location of the recursive DNS or end-user client, server load, and other factors. Note that the DNS resolution process may involve multiple stages, e.g., a top level stage that returns an intermediate domain name, which is a resolved in a second-level domain name resolution yielding an actual IP address. The particulars of the process are not crucial or limiting for the teachings hereof. Once an IP address for the selected CDN server is returned to the recursive DNS server, the recursive DNS returns that IP address to the client machine. The determination of which CDN server or set of CDN servers should be used to respond to a particular client machine is sometimes referred to as ‘mapping’ the client machine. As mentioned, the “best” mapping may be based on a variety of factors such as network distance to client location, load, likelihood of having the requested object.

For cacheable content, CDN servers 102 typically employ a caching model that relies on setting a time-to-live (TTL) for each cacheable object. After it is fetched, the object may be stored locally at a given CDN server until the TTL expires, at which time is typically re-validated or refreshed from the origin server 106. For non-cacheable objects (sometimes referred to as ‘dynamic’ content), the CDN server 102 typically returns to the origin server 106 when the object is requested by a client. The CDN may operate a server cache hierarchy to provide intermediate caching of customer content in various CDN servers 102 that are between the CDN server 102 handling a client request and the origin server 106; one such cache hierarchy subsystem is described in U.S. Pat. No. 7,376,716, the disclosure of which is incorporated herein by reference.

Although not shown in detail in FIG. 1, the CDN may also include other infrastructure, such as a distributed data collection system 108 that collects usage and other data from the CDN servers 102, aggregates that data across a PoP or set of PoPs, and passes that data to other back-end systems 110, 112, 114 and 116 to facilitate monitoring, logging, alerts, billing, management and other operational and administrative functions. Distributed network agents 118 monitor the network as well as the server loads and provide network, traffic and load data to a DNS query handling mechanism 115. A distributed data transport mechanism 120 may be used to distribute control information (e.g., metadata to manage content, to facilitate load balancing, and the like) to the CDN servers 102.

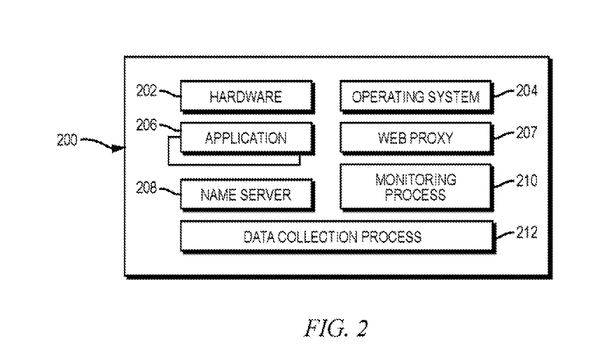

As illustrated in FIG. 2, a given machine 200 in the CDN typically comprises commodity hardware 202 (e.g., a microprocessor) running an operating system kernel 204 (such as Linux® or variant) that supports one or more applications 206. To facilitate content delivery services, for example, given machines typically run a set of applications, such as an HTTP proxy server 207, a name service 208, a local monitoring process 210, a distributed data collection process 212, and the like. The HTTP proxy 207 typically includes a manager process for managing a cache and delivery of content from the machine. For streaming media, the machine may include one or more media servers, as required by the supported media formats.

A given CDN server 102 shown in FIG. 1 may be configured to provide one or more extended content delivery features, preferably on a domain-specific, content-provider-specific basis, preferably using configuration files that are distributed to the CDN servers 102 using a configuration system. A given configuration file preferably is XML-based and includes a set of content handling rules and directives that facilitate one or more advanced content handling features. The configuration file may be delivered to the CDN server 102 via the data transport mechanism. U.S. Pat. No. 7,240,100, the content of which is hereby incorporated by reference, describe a useful infrastructure for delivering and managing CDN server content control information and this and other control information (sometimes referred to as “metadata”) can be provisioned by the CDN service provider itself, or (via an extranet or the like) the content provider customer who operates the origin server. More information about a CDN platform can be found in U.S. Pat. Nos. 6,108,703 and 7,596,619, the teachings of which are hereby incorporated by reference in their entirety.

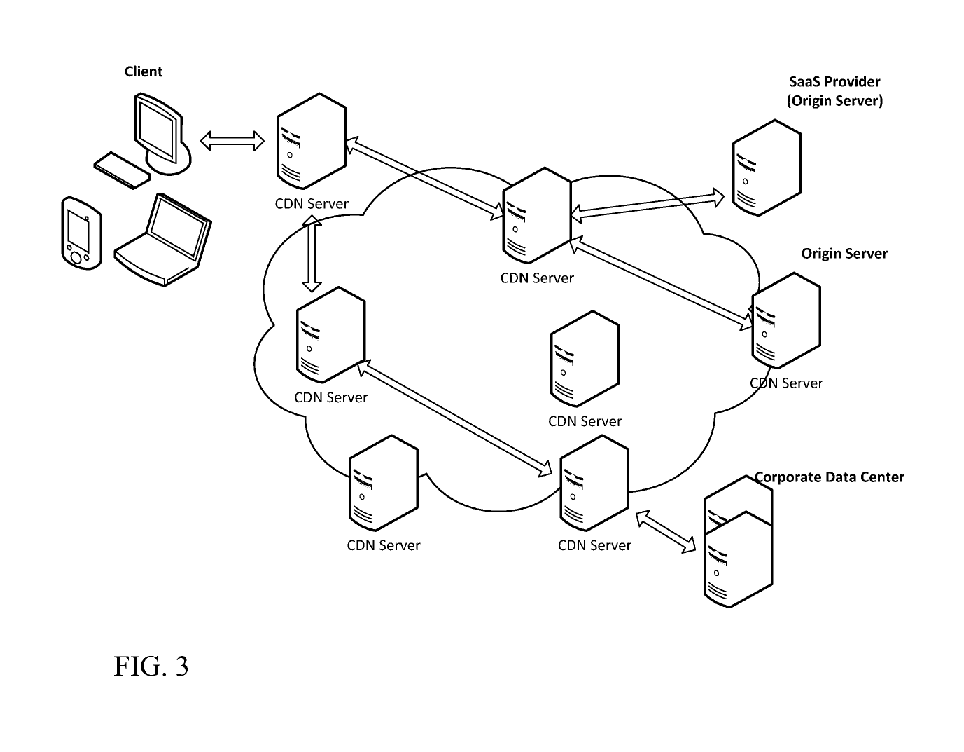

The CDN platform may be considered an overlay across the Internet on which communication efficiency can be improved. Improved communications on the overlay can accelerate communication when a CDN server 102 needs to obtain content from an origin server 106 or otherwise when accelerating non-cacheable content. As an overlay offering communication enhancements and acceleration, the CDN server resources may be used to facilitate wide area network (WAN) acceleration services between enterprise data centers and/or between branch-headquarter offices (which may be privately managed), as well as to/from third party software-as-a-service (SaaS) providers used by the enterprise users. FIG. 3 generally illustrates the notion of the overlay. Note that each CDN server shown in FIG. 3 is typically one of several at a given PoP; for convenience of illustration only one machine is shown. Communications between CDN servers across the overlay may be enhanced or improved using improved route selection, protocol optimizations including TCP enhancements, persistent connection reuse and pooling, content & header compression and de-duplication, and other techniques such as those described in U.S. Pat. Nos. 6,820,133, 7,274,658, 7,607,062, and 7,660,296, among others, the teachings of which are incorporated herein by reference.

Finally, for live streaming delivery, the CDN may include a live delivery subsystem, such as described in U.S. Pat. No. 7,296,082, and U.S. Publication Nos. 2011/0173345 and 2012/0265853, the disclosures of which are incorporated herein by reference.

Multipath TCP

At a high level, and in the context of a distributed computing system such as the CDN described above, multipath TCP functions can be leveraged to perform any or all of the following:
Path Redundancy—Get path redundancy from a client to multiple PoPs for use in transmitting data across the overlay. Path redundancy can also be used when communicating between two CDN servers in the overlay (see FIG. 3), in the so-called “middle-mile”.
Connection Migration—Migrate long-lived TCP connections from one server in the distributed computing system to another. (This includes migrating from a first server in a first PoP to a second server in a second PoP.)
End User Mapping—Migrate a client to a better server than it is initially mapped to, based on the client's actual IP address (whereas the initial mapping is typically based on the IP address of the client's local (recursive) DNS server, as described above, even though the recursive DNS may be remote from the client and thus result in a suboptimal mapping). In addition, in some cases, a client may be mobile, and thus the “closest” server to the client may change as the client moves (in this respect, see also the Multi-Interface use case described below).
Object Delivery—Migrate TCP connections from one server to another (including from a server in one PoP to a server in another PoP) before delivery of large objects and/or objects that are sensitive (e.g., objects that are kept in a particular security-hardened machine and/or PoP) to the client.
Cache Hierarchy—Have the client connect both to a given server and its cache hierarchy parent. Alternatively, have the client connect to a given server using single path TCP, and have that server connect using MPTCP to a cache hierarchy parent server, assuming the parent server is multihomed in more than one network. Alternatively, have the client connect via MPTCP with subflows to multiple servers, as mentioned above in Path Redundancy, and have those servers connect using MPTCP to the cache hierarchy parent server.
Multi-Interface—Have a client use MPTCP to connect to one or more servers using both the client's WiFi and cellular interfaces, using at least one subflow for each. This approach differs from typical MPTCP use case because a CDN may have one server that is considered the “best”—due to latency, load, cost, or other metrics—for the Wifi interface, and another server that is considered “best” for the cellular interface. For example: (1) Client_Wifi_interface connects to Server_Wifi_interface via one subflow; (2) Client initiates its cellular radio access network (RAN) interface; (3) Client_Cellular_interface connects to Server_WiFi_interface (as the client still has that as its DNS resolution); (4) Server_WiFi_interface instructs Client to establish an additional connection or connection subflow to Server_Cellular_interface. Once the additional connection or subflow is established, the traffic flow is handed off to it.
IPv4/IPv6—Have a client use MPTCP to connect to one or more servers using IPv4 and IPv6, using at least one subflow for each, and then switch to the one that delivers better performance (as determined through round trip time calculations or other performance measurements made on the subflow). IPv4 and IPv6 throughput and latency may differ. This approach allows for fast establishment of a connection to a nearby IPv4 server and a nearby IPv6 server, but then converge on the most preferable server (due to performance, cost or other consideration). Note that in one variation of the foregoing, one server could have both an IPv4 and IPv6 interface and the approach converges on the interface that is best.
Assume a virtual IP (VIP) is used for identification of traffic in a multi-tenant server platform such as a CDN (e.g., a VIP indicates traffic associated with a given tenant or a particular domain or category of content of the given tenant). With this in mind, another use case is migration from SSL/TLS virtual IP address on an initial CDN server (or other protocol needing a virtual IP for multi-tenant server identification) to shared IP on a nearer or otherwise “better” server. After completing an SSL/TLS handshake on the dedicated VIP in a small number of locations, the initial server can migrate the client connection to another server on a shared IP address.
Migration from Anycast IP address to non-Anycast IP addresses. Client can connect to an Anycast IP address (connecting to an initial server) and then the initial server can migrate the connection to another server on a non-Anycast IP address.

For all of the modes provided above, all subflows can be active simultaneously, with a goal of increasing performance, or in other cases only one subflow can be active but with the second subflow being set up and ready to take over as a backup whenever there is a problem such as performance degradation with the first subflow.

### Operational Examples

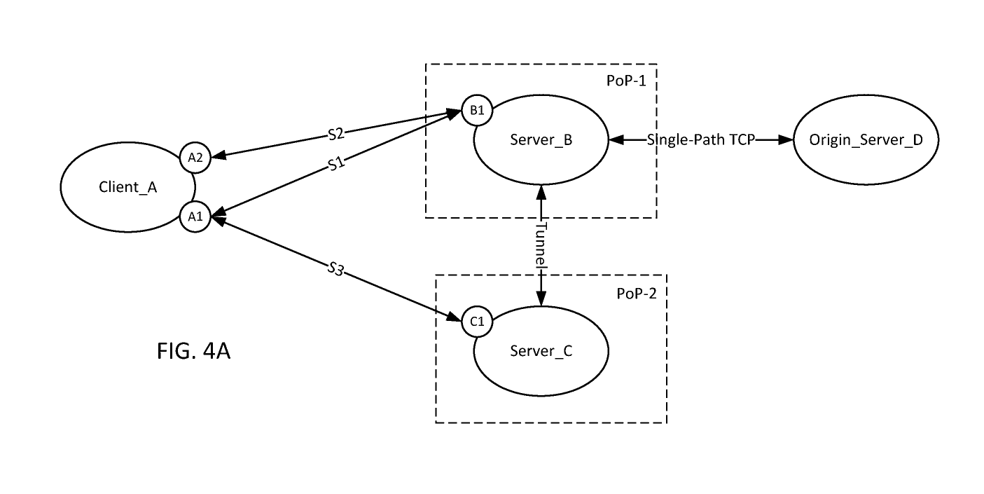

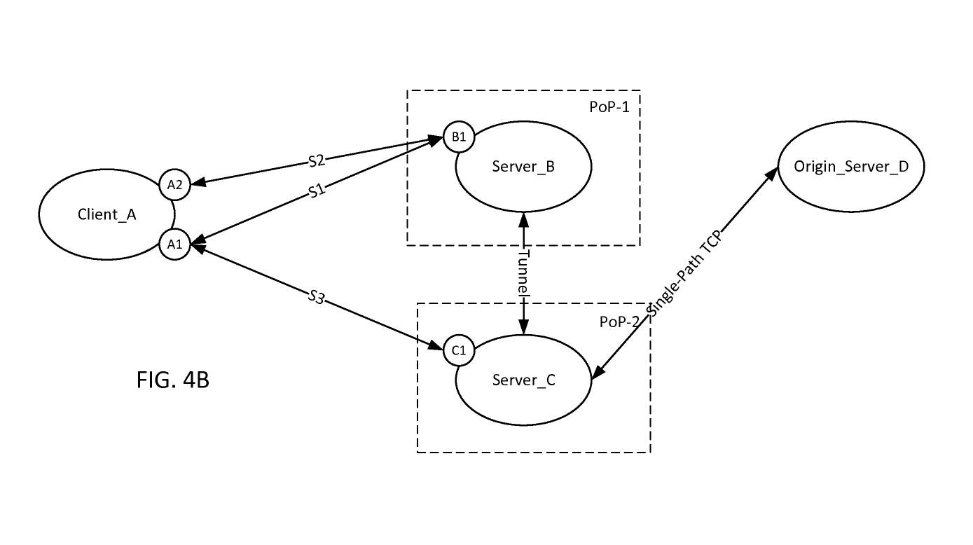

FIG. 4A shows a schematic view of a client device (referred to as Client_A) and multiple servers (referred to as Server_B and Server_C) in a CDN. In operation, the methodology proceeds as follows:
1. Establish an initial MPTCP connection S1 between address A1 of Client_A and address B1 of Server_B, where A1 and B1 denote addresses of Client_A and Server_B, respectively (e.g., IP addresses). For this example, let the client establish a subflow S2 between A2 and B1, per conventional MPTCP operation. Per MPTCP convention, the establishment of an MPTCP-capable connection (the first subflow) uses the MP_CAPABLE option in the TCP handshake (in the SYN, SYN/ACK/ACK messages) and further involves an exchange of key material as detailed in RFC 6824. Additional subflows then can be added, with the key material being used to authenticate the endpoints.
2. Determine at Server_B that we want to invoke multipath to another server in the platform. The determination to invoke multipath may be based on the desire to invoke or achieve one or more of the use cases described previously. For example, initiating multipath will provide path redundancy. As another example, if Server_B determines that the Client_A is poorly mapped, it can initiate multipath for end user mapping purposes. As another example, if a client session indicates a need for an object above a particular threshold (size) or having a particular sensitivity level (e.g., bank account data), then the Server_B can initiate multipath so that delivery of that object can be made from another server, which may be in another PoP. If Client_A makes a request for content associated with a given content provider that is known to be, or known to be likely to be, stored upstream in the network (such as long-tail content, also referred to as cold content), then Server_B can initiate multipath so as to get a cache hierarchy parent involved. These are merely examples.
3. Server_B initiates multipath by sending a message with an ADD_ADDR MPTCP option to Client_A with Server_C's address C1. This informs Client_A of address C1 and enables it to add a new subflow to the MPTCP connection to C1, at a later time. The new subflow is added using an MP_JOIN handshake message to C1. The MP_JOIN handshake also involves SYN, SYN, ACK, ACK messages with MP_JOIN flag. While convention says that the client may act on the ADD_ADDR by initiating the MP_JOIN handshake, note that the teachings hereof contemplate, in a non-limiting embodiment, a modified client that must act on the ADD_ADDR. (Alternatively, Server_B can send an MP_JOIN MPTCP option to Client_A with C1 to implicitly add C1 of Server_C in a new subflow, but in this case, Server_C would have to complete the handshake to establish the subflow using C1 and the appropriate key material.)
4. In parallel with the ADD_ADDR above, Server_B communicates to Server_C, potentially over a protocol specific to the distributed computing platform, to tell Server_C to prepare for a connection from Client_A. Server_B can pass to Server_C a set of information about the MPTCP connection, including for example the key material exchanged during the MP_CAPABLE handshake with Client_A, tokens, nonces, and address IDs, and TCP state information, sequence numbers. Examples of mechanisms for session state migration for a TCP connection can be found in IETF Internet Draft titled TCP Connection Migration, draft-snoeren-tcp-migrate-00.txt (2000), the contents of which are incorporated by reference. Server_C can then use this information in the MP_JOIN that is expected to occur as a result of the ADD_ADDR sent to Client_A, and/or in subsequently establishing other subflows. Also at this time, Server_B may also pass other relevant information to Server_C, for example HTTP session state information and the like.
5. When Client_A responds to the ADD_ADDR by creating a TCP connection (and MPTCP subflow S3) from A1 to C1, Server_C relays this information back to Server_B (via an IP in IP tunnel, for example, illustrated in FIG. 4A as “Tunnel”). At this point, we have path redundancy as TCP segments can either go over S1, S2, and/or S3+Tunnel. Server_B is used to go forward to Origin_Server_D using “traditional” single-path TCP if needed for cache misses, dynamic content, or otherwise. Note that the endpoint addresses on this single path (e.g., B1 and D1) are not shown for simplicity of illustration. Cached content may be served from Server_B or Server_C. Observe that we have now created multiple paths and provided multiple resources to Client_A. This provides a measure of redundancy, fault tolerance, and performance enhancement over the so-called “last mile” of content delivery between Client_A and the servers.
6. If it is decided that S3 is better than S1/S2, or that Server_C is better than Server_B, Server_B may hand off its role as master for the MPTCP connection to Server_C. This decision may be based, for example, server load, likelihood of having objects, or other reasons, including a determination that the initial mapping was poor. At a point in the session, Server_B hands off state to Server_C and the path redundancy essentially changes to the arrangement shown in FIG. 4B, with Server_C thereafter establishing and using a TCP connection to handle go-forward communications with the origin.
7. In some cases, a complete connection migration can be performed by having Server_B or Server_C send a REMOVE_ADDR of B1. This would remove S1 and S2 from FIG. 4B. The TCP connection has thus been migrated from Server_B to Server_C and indeed from PoP to PoP in this case. It should be clear, however, that this step is optional, as subflows to separate servers also could be maintained throughout the session.
8. In some cases, the priority option in MPTCP (MP_PRIO) can be send to Client_A to force Client_A to use one of S1, S2, or S3 as the primary with the others only for backup. This effectively achieves a connection migration without actually severing the backup subflow, and is referred to below as a ‘virtual migration’.

Note that the foregoing steps could be repeated as necessary to add more servers (e.g., Server_D, Server_E), if desired.

Below is the previously-recited list of potential use cases and how FIGS. 4A and 4B (with the workflow described above) can be applied to each. These are merely examples.
Path Redundancy
   S1, S2 and (S3+Tunnel) provide path redundancy between Client_A and the servers, and effectively between the Client_A and the Origin_Server_D.
Connection Migration
   As described in steps 7 and 8, above, and shown by the transition from FIGS. 4A to 4B, a TCP connection can be migrated or virtually migrated from Server_B to Server_C. This process can be initiated when a TCP connection is long-lived and e.g., exceeds a particular duration.
End User Mapping
   There are many possible reasons to change mapping for an end user client. For example, if Server_B is determined to be a suboptimal choice for Client_A, then the connection can be migrated to Server_C.
   Also, consider that Client_A might be a mobile client. Accordingly, Client_A might move from Wifi network to cellular connection to Wifi network, or from Wifi to Wifi network. This may mean that, while Server_B was originally the closest or otherwise best-mapped server, Server_C may become so as the client moves. In this situation, a new subflow can be added between Client_A and Server_C, per the techniques described above. And the old subflow(s) to Server_B can be terminated if it is no longer efficient to send data over that subflow.
Object Delivery
   In this use case, the TCP connection is migrated or virtually migrated based upon a determination that another server is better suited to deliver a particular kind of object, such as a “large” object, and object of a given type (e.g., video), or sensitive objects that are stored in security-hardened servers. Applying this to FIGS. 4A-B, Server_B can add/migrate to Server_C, as above, to deliver large or specialized objects, or because Server_B determines that the client is requesting SSL/TLS encryption or otherwise that the session will involve sensitive data, and Server_C is a more secure server.
Cache Hierarchy—by having a client connect both to a given server and its cache hierarchy parent. Alternatively, have the client connect to multiple PoPs, and have the servers connect over multiple paths to a cache hierarchy parent.
Multi-Interface
   Each of the subflows (S1/A1 and S2/A2 and S3/A1) can be used for one of the Client_A's interfaces, e.g., cellular for Wifi for S1 and cellular for S3.
IPv4/v6
   As noted earlier, one server may be connected to using an IPv4 interface, and another via IPv6. Thus in FIG. 4A, B1 might be a IPv4 interface, and C1 might be an IPv6 interface.
Migration from Anycast to Non-Anycast
   In this example, Server_B's address B1 can be an Anycast address and Server_B's address C1 can be a non-Anycast address.

Modified Client

While the teachings hereof can be used with a conventional client device with MPTCP support, such as a desktop, laptop, or wireless device running an appropriate browser or other content viewer application, the use of a client modified specifically to support the teachings hereof is also contemplated. The term ‘modified client’ is meant to include native programming in the client's operating system, client application, and/or browser plugins as well as hardware/integrated circuit implementations.

Such a modified client may be programmed to act in ways that are not necessarily reflected in standard MPTCP, for example by always responding to an ADD_ADDR option by initiating a new subflow to the added address, e.g., after some predetermined time. Such a modified client may also be programmed to prioritize or schedule object requests across S1, S2 and/or S3. One example of such prioritization is to take into account the type of connections the client has. If one connection is fast but expensive (e.g., 4G cellular) and another connection is crowded but cheap (e.g., public Wifi), then the requests for objects or object types deemed critical for rendering of a website might be directed over the cellular link and the non-critical requests over the Wifi link. Another example of such prioritization is to take into account the characteristics of the servers (e.g., Server_B vs. Server_C) in the distributed computing platform, which characteristics may be communicated by the servers themselves. In this case, requests for certain object-types may be directed to one of the servers over the other. Similarly, requests for content with certain security characteristics may be directed to one of the servers over the other.

Origin Server Multipath

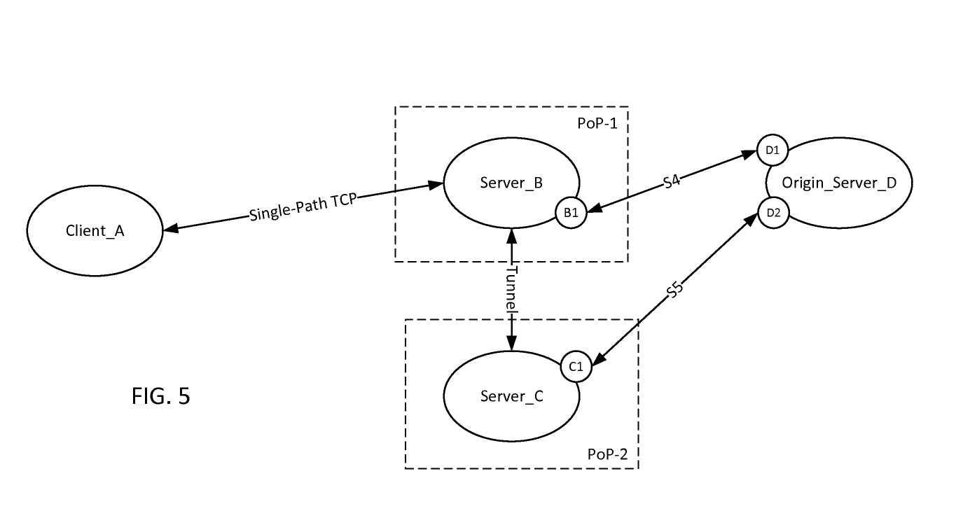

While FIGS. 4A-B illustrate the use of multipath TCP to establish multiple paths between a client device and CDN servers, the same techniques can be used between CDN servers and an origin server. FIG. 5 illustrates an example of multipath on the origin server side. (Note that in FIG. 5 the endpoint addresses on the single path between Client_A and Server_B (e.g., A1 and B1) are not shown for simplicity of illustration.) By employing multipath on the origin server side, the same benefits can be obtained as on the client side, such as path diversity, and fault tolerance from being connected to multiple PoPs. Further, the connection to the Origin_Server_D can be migrated from Server_B in PoP-1 to Server_C in PoP-2 as detailed in steps 7 and 8 above. Yet further, while FIG. 5 shows a single-path TCP connection to the client, in fact multipath can be employed on both the client side and origin side—that is, the subflows S1, S2, S3 can be established between Client_A and Server_B/Server_C as shown in FIG. 4A, with subflows S4 and S5 also being established between Server_B/Server_C and Origin_Server_D in the manner shown in FIG. 5. Finally, also note that while FIGS. 4A-5 depict a single address for the servers (B1 and C1), the servers could also have multiple interfaces and addresses.

Computer Based Implementation

The subject matter described herein may be implemented with computer systems, as modified by the teachings hereof, with the processes and functional characteristics described herein realized in special-purpose hardware, general-purpose hardware configured by software stored therein for special purposes, or a combination thereof

Software may include one or several discrete programs. A given function may comprise part of any given module, process, execution thread, or other such programming construct. Generalizing, each function described above may be implemented as computer code, namely, as a set of computer instructions, executable in one or more microprocessors to provide a special purpose machine. The code may be executed using conventional apparatus—such as a microprocessor in a computer, digital data processing device, or other computing apparatus—as modified by the teachings hereof. In one embodiment, such software may be implemented in a programming language that runs in conjunction with a proxy on a standard Intel hardware platform running an operating system such as Linux. The functionality may be built into the proxy code, or it may be executed as an adjunct to that code.

While in some cases above a particular order of operations performed by certain embodiments is set forth, it should be understood that such order is exemplary and that they may be performed in a different order, combined, or the like. Moreover, some of the functions may be combined or shared in given instructions, program sequences, code portions, and the like. References in the specification to a given embodiment indicate that the embodiment described may include a particular feature, structure, or characteristic, but every embodiment may not necessarily include the particular feature, structure, or characteristic.

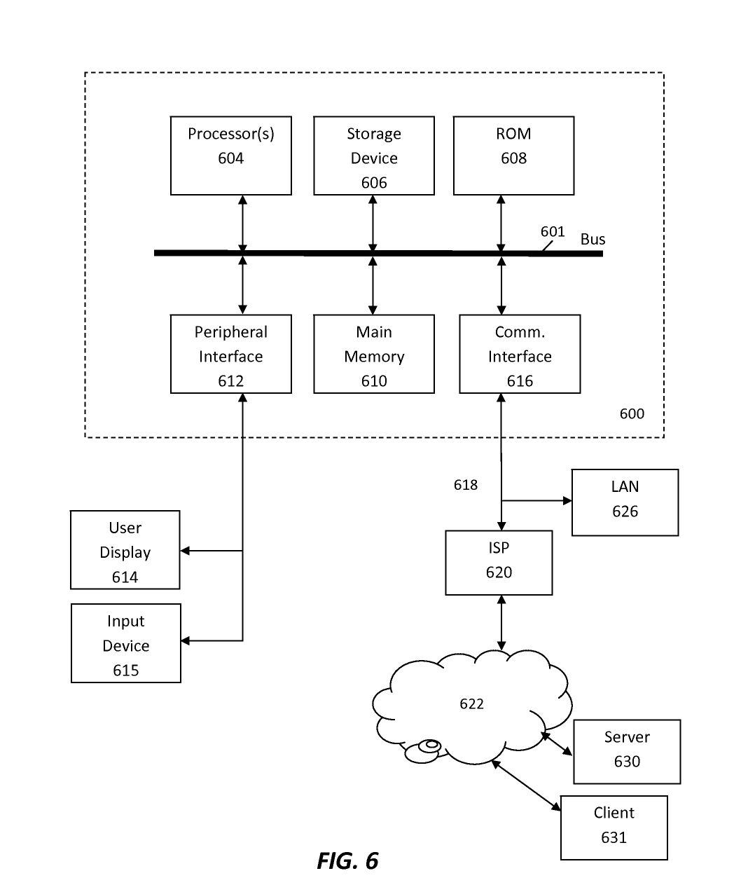

FIG. 6 is a block diagram that illustrates hardware in a computer system 600 on which embodiments of the invention may be implemented. The computer system 600 may be embodied in a client device, server, personal computer, workstation, tablet computer, wireless device, mobile device, network device, router, hub, gateway, or other device.

Computer system 600 includes a microprocessor 604 coupled to bus 601. In some systems, multiple microprocessor and/or microprocessor cores may be employed. Computer system 600 further includes a main memory 610, such as a random access memory (RAM) or other storage device, coupled to the bus 601 for storing information and instructions to be executed by microprocessor 604. A read only memory (ROM) 608 is coupled to the bus 601 for storing information and instructions for microprocessor 604. As another form of memory, a non-volatile storage device 606, such as a magnetic disk, solid state memory (e.g., flash memory), or optical disk, is provided and coupled to bus 601 for storing information and instructions. Other application-specific integrated circuits (ASICs), field programmable gate arrays (FPGAs) or circuitry may be included in the computer system 600 to perform functions described herein.

Although the computer system 600 is often managed remotely via a communication interface 616, for local administration purposes the system 600 may have a peripheral interface 612 communicatively couples computer system 600 to a user display 614 that displays the output of software executing on the computer system, and an input device 615 (e.g., a keyboard, mouse, trackpad, touchscreen) that communicates user input and instructions to the computer system 600. The peripheral interface 612 may include interface circuitry and logic for local buses such as Universal Serial Bus (USB) or other communication links.

Computer system 600 is coupled to a communication interface 616 that provides a link between the system bus 601 and an external communication link. The communication interface 616 provides a network link 618. The communication interface 616 may represent an Ethernet or other network interface card (NIC), a wireless interface, modem, an optical interface, or other kind of input/output interface.

Network link 618 provides data communication through one or more networks to other devices. Such devices include other computer systems that are part of a local area network (LAN) 626. Furthermore, the network link 618 provides a link, via an internet service provider (ISP) 620, to the Internet 622. In turn, the Internet 622 may provide a link to other computing systems such as a remote server 630 and/or a remote client 631. Network link 618 and such networks may transmit data using packet-switched, circuit-switched, or other data-transmission approaches.

In operation, the computer system 600 may implement the functionality described herein as a result of the microprocessor executing program code. Such code may be read from or stored on a non-transitory computer-readable medium, such as memory 610, ROM 608, or storage device 606. Other forms of non-transitory computer-readable media include disks, tapes, magnetic media, CD-ROMs, optical media, RAM, PROM, EPROM, and EEPROM. Any other non-transitory computer-readable medium may be employed. Executing code may also be read from network link 618 (e.g., following storage in an interface buffer, local memory, or other circuitry).

A client device may be a conventional desktop, laptop or other Internet-accessible machine running a web browser or other rendering engine, but as mentioned above a client may also be a mobile device. Any wireless client device may be utilized, e.g., a cellphone, pager, a personal digital assistant (PDA, e.g., with GPRS NIC), a mobile computer with a smartphone client, tablet or the like. Other mobile devices in which the technique may be practiced include any access protocol-enabled device (e.g., iOS™-based device, an Android™-based device, other mobile-OS based device, or the like) that is capable of sending and receiving data in a wireless manner using a wireless protocol. Typical wireless protocols include: WiFi, GSM/GPRS, CDMA or WiMax. These protocols implement the ISO/OSI Physical and Data Link layers (Layers 1 & 2) upon which a traditional networking stack is built, complete with IP, TCP, SSL/TLS and HTTP. The WAP (wireless access protocol) also provides a set of network communication layers (e.g., WDP, WTLS, WTP) and corresponding functionality used with GSM and CDMA wireless networks, among others.

In a representative embodiment, a mobile device is a cellular telephone that operates over GPRS (General Packet Radio Service), which is a data technology for GSM networks. Generalizing, a mobile device as used herein is a 3G-(or next generation) compliant device that includes a subscriber identity module (SIM), which is a smart card that carries subscriber-specific information, mobile equipment (e.g., radio and associated signal processing devices), a man-machine interface (MMI), and one or more interfaces to external devices (e.g., computers, PDAs, and the like). The techniques disclosed herein are not limited for use with a mobile device that uses a particular access protocol. The mobile device typically also has support for wireless local area network (WLAN) technologies, such as Wi-Fi. WLAN is based on IEEE 802.11 standards. The teachings disclosed herein are not limited to any particular mode or application layer for mobile device communications.

It should be understood that the foregoing has presented certain embodiments of the invention that should not be construed as limiting. For example, certain language, syntax, and instructions have been presented above for illustrative purposes, and they should not be construed as limiting. It is contemplated that those skilled in the art will recognize other possible implementations in view of this disclosure and in accordance with its scope and spirit. The appended claims define the subject matter for which protection is sought.

It is noted that trademarks appearing herein are the property of their respective owners and used for identification and descriptive purposes only, given the nature of the subject matter at issue, and not to imply endorsement or affiliation in any way.

1. A method of establishing a multipath TCP connection, comprising:
at a first server, receiving from a client device one or more handshake messages indicating multipath TCP support, and in response thereto, establishing a first subflow of a TCP connection between the first server and the client device;
the first server sending an add address message to the client device over the first subflow, the add address message including an address of a second server, the second server being physically separate from the first server;
the second server receiving from the client device one or more multipath join messages and in response thereto establishing a second subflow of the TCP connection between the client device and the second server.

2. The method of claim 1, wherein the first server sends information to the second server to prepare the second server to establish the second subflow, the information including key material.

3. The method of claim 1, wherein the one or more handshake messages indicating multipath TCP support comprise one or more messages with an MP-CAPABLE option, and the add address message is a message with an MP_ADD_ADDR option, and the one or more multipath join messages comprise one or more messages with an MP_JOIN option.

4. The method of claim 1, wherein the second server receives data from the client device over the second subflow, and the second server relays the data to the first server.

5. The method of claim 1, further comprising the first server or second server sending a remove address message to the client device with the address of the first server.

6. The method of claim 1, further comprising the first server or second server sending a priority message to the client specifying that the first subflow is a backup.

7. The method of claim 1, wherein one of the first and second servers is a cache-parent of the other.

8. The method of claim 1, wherein the first server determines to send the add address message based at least in part on any of (i) the second server being more closely located to the client device than the first server, (ii) the second server being more lightly loaded than the first server, and (iii) the second server being more likely to have content requested by the content than the first server.

9. The method of claim 1, wherein the first server determines to send the add address message based at least in part on the client device connecting to a new wireless network.

10. The method of claim 1, wherein any of (i) the second server is more suited to deliver a particular content type compared to the first server and (ii) the second server provides security features not found with the first server.

11. The method of claim 1, wherein the first server is a first PoP and the second server is in a second PoP that is remote from the first PoP.

12. A method of establishing a multipath TCP connection, comprising:
at a first server, receiving from a client device one or more handshake messages indicating multipath TCP support, and in response thereto establishing a first subflow of a TCP connection between the first server and the client device;
the first server sending a multipath join message to the client device over the first subflow, the multipath join message including an address of a second server that is physically separate from the first server, and in response thereto, establishing a second subflow of the TCP connection between the second server and the client device;
the second server receiving data from the client device over a second subflow of the TCP connection.

13. The method of claim 12, further comprising the first server sending information to the second server, to prepare the second server to establish the second subflow, the information including key material.

14. The method of claim 12, wherein the one or more handshake messages indicating multipath TCP support comprise one or more messages with an MP-CAPABLE option, and the add address message is a message with an MP_ADD_ADDR option, and the one or more multipath join messages comprise one or more messages with an MP_JOIN option.

15. The method of claim 12, wherein the second server receives data from the client device over the second subflow, and the second server relays the data to the first server.

16. The method of claim 12, further comprising the first server or second server sending a remove address message to the client device with the address of the first server.

17. The method of claim 12, further comprising the first server or second server sending a priority message to the client specifying that the first subflow is a backup.

18. The method of claim 12, wherein one of the first and second servers is a cache-parent of the other.

19. The method of claim 12, wherein the first server determines to send the multipath join message based at least in part on any of (i) the second server being more closely located to the client device than the first server, (ii) the second server being more lightly loaded than the first server, and (iii) the second server being more likely to have content requested by the content than the first server.

20. The method of claim 12, wherein the first server determines to send the multipath join message based at least in part on the client device connecting to a new wireless network.

21. The method of claim 12, wherein the first server is a first PoP and the second server is in a second PoP that is remote from the first PoP.

22. A method of establishing a multipath TCP connection, comprising:
at a first server, receiving from an origin server one or more handshake messages indicating multipath TCP support, and in response thereto, establishing a first subflow of a TCP connection between the first server and the origin server;
the first server sending an add address message to the origin server over the first subflow, the add address message including an address of a second server, the second server being physically separate from the first server;
the second server receiving from the origin server one or more multipath join messages and in response thereto establishing a second subflow of the TCP connection between the origin server and the second server.

23. A method of establishing a multipath TCP connection, comprising:
at a first server, receiving from an origin server one or more handshake messages indicating multipath TCP support, and in response thereto establishing a first subflow of a TCP connection between the first server and the origin server;
the first server sending a multipath join message to the client device over the first subflow, the multipath join message including an address of a second server that is physically separate from the first server, and in response thereto, establishing a second subflow of the TCP connection between the second server and the origin server;
the second server receiving data from the origin server over a second subflow of the TCP connection.
